(19) United States
(12) Patent Application Publication
(10) Pub. No.: US 2015/0129793 A1
(43) Pub. Date: May 14, 2015

(54) METHODS OF MAKING NANOPARTICLE COMPOSITES

(71) Applicant: Nanjing University, Nanjing (CN)

(72) Inventor: Gang RUAN, Nanjing (CN)

(21) Appl. No.: 14/538,516

(22) Filed: Nov. 11, 2014

Related U.S. Application Data
(60) Provisional application No. 61/902,676, filed on Nov. 11, 2013.

(51) Int. Cl. C09K 11/02; H01F 1/01

(52) U.S. Cl. CPC C09K 11/025; H01F 1/01; Y10S 977/774; Y10S 977/783; Y10S 977/84; B82Y 40/00
USPC 252/62.54; 252/301.36; 977/774; 977/783; 977/840

(57) ABSTRACT

The present invention provides a novel method to synthesize composite nanoparticle structures combining the functions of individual nanoparticle components, such as quantum dots, gold nanoparticles and iron oxide nanoparticles. This novel technology solves some of the major problems of the commonly used synthesis methods such as poorly-controlled ratios between different components in a composite nanoparticle. This platform technology has great potential in applying nanotechnology in biomedical detection and imaging, solar cells, as well as environmental monitoring.

### CROSS-REFERENCE TO RELATED APPLICATIONS

This invention claims the benefit of U.S. provisional application No. 61/902,676, filed on Nov. 11, 2013, the teaching of which is incorporated herein in its entirety by reference.

### FIELD OF THE DISCLOSURE

The present invention relate to nanoparticles, methods for producing nanoparticles, and methods of using the same.

### BACKGROUND OF THE DISCLOSURE

Nanoscale materials with a single component and function, such as quantum dots, superparamagnetic iron oxide nanoparticles, and carbon nanotubes, have been widely applied in a number of fields, including biomedicine, energy, environment, among others. Recently, composite nanoparticles, i.e. nanoparticles combining two (or more) nano-species to achieve bi-function (or multi-function) or offer new functions not available from any individual component have become an emerging new class of nanomaterials. These novel nanoparticle materials represent a major step forward in nanotechnology in terms of both materials fabrication and their application. However, major challenges have been found in synthesizing composite nanoparticles which are more complex structures than individual nanoparticles. Some of these challenges include poor control of ratio of the numbers of different nanospecies in a composite nanoparticle (or in other words the “molecular formula” of a composite nanoparticle), loss of function from a single nanospecies after forming the composite, etc.

The embodiments described below address the above identified issues and needs.

### SUMMARY OF THE DISCLOSURE

In one aspect of the present invention, it is provided a method for producing a composite nanoparticle structure, the method comprising:

providing a plurality of nanoparticle-polymer hybrid amphiphiles (NPHAs), and

causing the plurality of NPHAs to spontaneously assemble into a composite nanoparticle structure.

In some embodiments of the method, the composite nanoparticle structure comprises at least 2 NPHAs, at least 5 NPHAs, or at least 10 NPHAs.

In some embodiments of the method, optionally in combination with one or more of the above various embodiments, the NPHA comprises:

(a) a hydrophobic nanoparticle and a hydrophilic polymer, or

(b) a hydrophilic nanoparticle and a hydrophobic polymer.

In some embodiments of the method, optionally in combination with one or more of the above various embodiments, the NPHA comprises a hydrophobic nanoparticle and a hydrophilic polymer. Examples of hydrophobic nanoparticles include, but are not limited to, hydrophobic semiconductor quantum dots, precious metal nanoparticles, polymer nanoparticles, lipid nanoparticles, iron oxide nanoparticles, carbon nanoparticles, carbon nanotubues, graphenes, fullerenes, nanowires, nanorods, and the derivatives and combinations thereof. Examples of the hydrophilic polymer include, but are not limited to, polyethylene glycol (or polyethylene oxide), polyanhydrides, poly (acrylic acids), polyacrylamide, poly (methyl vinyl ether), poly (styrene sulfonic acid), poly (vinyl alcohol), poly(2-vinyl N-methyl pyridinium iodide), poly(4-vinyl N-methyl pyridinium iodide), poly(vinylamine) poly(ethylene imine), and the derivatives and combinations thereof.

In some embodiments of the method, optionally in combination with one or more of the above various embodiments, the NPHA comprises a hydrophilic nanoparticle and a hydrophobic polymer. Example of the hydrophilic nanoparticles include, but not limited to, hydrophilic semiconductor quantum dots, precious metal nanoparticles, polymer nanoparticles, lipid nanoparticles, iron oxide nanoparticles, carbon nanoparticles, carbon nanotubues, graphenes, fullerenes, nanowires, nanorods, and the derivatives and combinations thereof.

These same nanoparticles can be hydrophobic or hydrophilic, depending on the surface treatment they receive.

Examples of the hydrophilic polymer include, but are not limited to, polyethylene glycol (or polyethylene oxide), polyanhydrides, poly (acrylic acids), polyacrylamide, poly (methyl vinyl ether), poly (styrene sulfonic acid), poly (vinyl alcohol), poly(2-vinyl N-methyl pyridinium iodide), poly(4-vinyl N-methyl pyridinium iodide), poly(vinylamine) poly(ethylene imine), and the derivatives and combinations thereof; and examples of the hydrophobic polymer include, but are not limited to, poly alkyl (acrylate), polydiene, poly imidazole, polylactone and polylactide, polyolefin, poly oxazoline, polyoxirane, polypyridine, polysiloxane, polystyrene, poly vinyl anthracene/phenanthrene, poly vinyl naphthalene, poly vinylcylcohexane, poly(acrylonitrile), poly(adipic anhydride), poly(ferrocenyldimethylsilane), poly(N-vinyl caprolactam), poly(N-vinyl carbazole), poly(Vinylidene fluoride), poly(vinyl acetate), poly(l-azabicyclo[4.2.0]octane) (polyconidine), poly[1-(trimethylsilyl)-1-propyne], and the derivatives and combinations thereof.

In some embodiments of the method, optionally in combination with one or more of the above various embodiments, causing the plurality of NPHAs to self-assemble into a composite nanoparticle structure comprises a process selected from any self-assembly process, including but not limited to film hydration, direct dissolution, nanoprecipitation, interfacial instability, dialysis, electrospray, extrusion, and sonication.

In some embodiments of the method, optionally in combination with one or more of the above various embodiments, causing the plurality of NPHAs to spontaneously assemble into a composite nanoparticle structure comprises dissolving the plurality of NPHAs in an organic solvent, and allowing the NPHAs to assemble into the composite nanoparticle structure. In some embodiments, the organic solvent is selected from the group consisting of chloroform, tetrahydrofuran, dichloromethane, and combinations thereof; the amphiphile is selected from the group consisting of poly(styrene-b-ethylene glycol), poly(.epsilon.-caprolactone-b-ethylene glycol), poly(ethylene glycol-b-distearoylphosphatidylethanolamine), a peptide amphiphile, dendrimer, and combinations thereof (not meant to be an exhaustive list); and the plurality of hydrophobic nanoparticles include, but are not limited to, semiconducting nanoparticles, metallic nanoparticles, such as precious metal nanoparticles, magnetic nanoparticles, semiconductor quantum dots, polymer nanoparticles, lipid nanoparticles, iron oxide nanoparticles, carbon nanoparticles, carbon nanotubues, graphenes, fullerenes, nanowires, nanorods, and the derivatives and combinations thereof.

In some embodiments of the method, optionally in combination with one or more of the above various embodiments, the composite nanoparticle structure has a diameter in a range of about 5 nm to about 1000 nm.

In some embodiments of the method, optionally in combination with one or more of the above various embodiments, the composite nanoparticle structure comprises at least one first quantum dot having a first emission wavelength and at least one second quantum dot having a second emission wavelength that is different from the first emission wavelength, and the composite nanoparticle structure has a diameter in a range of about 5 nm to about 1000 nm.

In some embodiments of the method, optionally in combination with one or more of the above various embodiments, the composite nanoparticle structure comprises at least one quantum dot and at least one magnetic nanoparticle, and the composite nanoparticle structure has a diameter in a range of about 5 nm to about 1000 nm.

In some embodiments of the method, optionally in combination with one or more of the above various embodiments, the composite nanoparticle structure further comprises a functional group, wherein the functional group is selected from the group consisting of a peptide, a polypeptide, a protein, a ligand, an antibody, DNA, RNA, and combinations thereof.

In some embodiments of the method, optionally in combination with one or more of the above various embodiments, the NPHAs comprise a nanoparticle selected from the group consisting of metallic nanoparticles, magnetic nanoparticles, carbonaceous nanoparticles, and combinations thereof.

In some embodiments of the method, optionally in combination with one or more of the above various embodiments, the first emission wavelength is between about 490 nm to about 560 nm and the second emission wavelength is between about 590 nm to about 700 nm.

In another aspect of the present invention, it is provided a composite nanoparticle structure comprising a plurality of nanoparticle-polymer hybrid amphiphiles (NPHAs), wherein the NPHA comprises:

(a) a hydrophobic nanoparticle and a hydrophilic polymer, or

(b) a hydrophilic nanoparticle and a hydrophobic polymer.

In some embodiments of the invention, the NPHA comprises a hydrophobic nanoparticle and a hydrophilic polymer,

wherein the hydrophobic nanoparticle can be, but are not limited to, semiconductor quantum dots, precious metal nanoparticles, polymer nanoparticles, lipid nanoparticles, iron oxide nanoparticles, carbon nanoparticles, carbon nanotubues, graphenes, fullerenes, nanowires, nanorods, and the derivatives and combinations thereof, and

wherein the hydrophilic polymer can be, but are not limited to, polyethylene glycol (or polyethylene oxide), polyanhydrides, poly (acrylic acids), polyacrylamide, poly (methyl vinyl ether), poly (styrene sulfonic acid), poly (vinyl alcohol), poly(2-vinyl N-methyl pyridinium iodide), poly(4-vinyl N-methyl pyridinium iodide), poly(vinylamine) poly(ethylene imine), and the derivatives and combinations thereof.

In some embodiments, optionally in combination with one or more of the above various embodiments, the NPHA comprises a hydrophilic nanoparticle and a hydrophobic polymer,

wherein the hydrophilic nanoparticle can be, but is not limited to, hydrophilic semiconductor quantum dots, precious metal nanoparticles, polymer nanoparticles, lipid nanoparticles, iron oxide nanoparticles, carbon nanoparticles, carbon nanotubues, graphenes, fullerenes, nanowires, nanorods, and the derivatives and combinations thereof, and

wherein the hydrophobic polymer can be, but is not limited to, poly alkyl (acrylate), polydiene, poly imidazole, polylactone and polylactide, polyolefin, poly oxazoline, polyoxirane, polypyridine, polysiloxane, polystyrene, poly vinyl anthracene/phenanthrene, poly vinyl naphthalene, poly vinylcylcohexane, poly(acrylonitrile), poly(adipic anhydride), poly(ferrocenyldimethylsilane), poly(N-vinyl caprolactam), poly(N-vinyl carbazole), poly(Vinylidene fluoride), poly(vinyl acetate), poly(l-azabicyclo[4.2.0]octane) (polyconidine), poly[1-(trimethylsilyl)-1-propyne], and the derivatives and combinations thereof.

In some embodiments, optionally in combination with one or more of the above various embodiments, the composite nanoparticle structure comprises at least one first quantum dot encapsulated in the micelle, the first quantum dot having a first emission wavelength; at least one second quantum dot encapsulated in the micelle, the second quantum dot having a second emission wavelength that is different from the first emission wavelength; and the composite nanoparticle structure having a diameter in a range of about 5 nm to about 1000 nm.

In some embodiments, optionally in combination with one or more of the above various embodiments, the composite nanoparticle structure further comprises at least one additional nanoparticle encapsulated in the micelle, the additional nanoparticle selected from the group consisting of metallic nanoparticles, magnetic nanoparticles, carbonaceous nanoparticles, and combinations thereof.

In some embodiments, optionally in combination with one or more of the above various embodiments, the first emission wavelength is between about 490 nm to about 560 nm and the second emission wavelength is between about 590 nm to about 700 nm.

Other aspects, advantages, and features of the present inventions will become apparent to those skilled in the art from the following detailed description, when read in light of the accompanying drawings.

### BRIEF DESCRIPTION OF THE DRAWINGS

FIG. 1 schematically illustrates one exemplary embodiment of a method for producing a composite nanoparticle structure.

### DETAILED DESCRIPTION

While the present inventions are susceptible of embodiment in many different forms, there are shown in the drawings, and will be described herein in detail, specific embodiments thereof with the understanding that the present disclosure is to be considered as an exemplification of the principles of the present inventions. Accordingly, the present inventions are not intended to be limited to the specific embodiments illustrated herein.

Unless otherwise defined, the terms used herein have the same meaning as commonly understood by one of ordinary skill in the art encompassing the present inventions. The terminology used herein is for describing exemplary embodiments of the present inventions only and is not intended to be limiting of the present inventions. As used in the description of the present inventions and the appended claims, the singular forms “a,” “an,” and “the” are intended to include the plural forms as well, unless the context clearly indicates otherwise.

### Composite Nanoparticle Structures

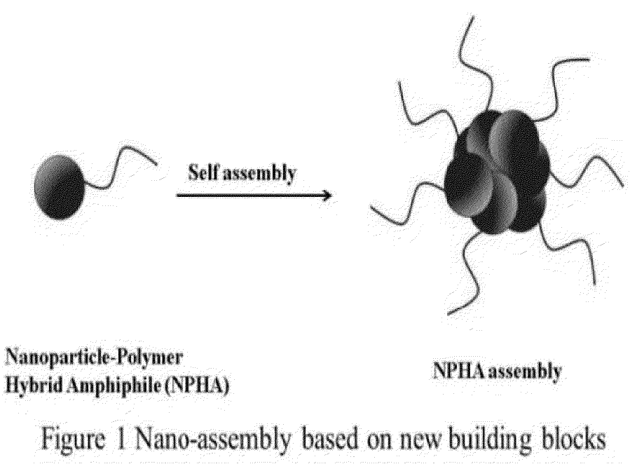

Here we describe a new method (FIG. 1) to synthesize composite nanoparticles which can solve some of the major problems in composite nanoparticle synthesis as mentioned above. This new method starts with a new component nanostructure called NPHA, and place it in a molecular environment that promotes its spontaneous assembly into a composite nanoparticle structure (FIG. 1). Because the formation of the composite nanoparticle is via self-assembly, whose final state is in thermodynamic equilibrium, the structure (including the “molecular formula”) of the composite nanoparticle is tightly controlled. This is in stark contrast to the commonly used microencapsulation-based preparation methods for composite nanoparticle synthesis, which are essentially kinetics-controlled and thus the control of the product is typically less than satisfactory.

The composite nanoparticle structure describes herein comprise a plurality of nanoparticle-polymer hybrid amphiphiles (NPHAs). As used herein, the term “nanoparticle-polymer hybrid amphiphile (NPHA)” refers to a nanoparticle attached or otherwise conjugated to a polymer where the nanoparticle and the polymer possess opposite hydrophobicity/hydrophilicyt nature so as to form an amphiphile. For example, a generally hydrophobic nanoparticle can have a generally hydrophilic polymer attached thereto to form a hydrophobic nanoparticle-hydrophilic polymer pair, which is an amphiphile. Conversely, a generally hydrophilic nanoparticle can have a generally hydrophobic polymer attached thereto to form a hydrophilic nanoparticle-hydrophobic polymer pair, which is also an amphiphile.

A necessary attribute of the NPHA disclosed herein is its ability to self-assemble into a composite nanoparticle structure disclosed herein when placed in molecular environment. Such molecular environment can be, for example, an aqueous or organic medium such as an organic solvent or an aqueous phase having a set of ionic, electric or pH values that promotes the NPHA to self-assemble. Such necessary attribute of the NPHA can be imparted by a stimulus sensitive group, for example, light sensitive group, pH sensitive group, ionic sensitive group, enzyme-sensitive, antigen-sensitive, glucose-sensitive, or temperature sensitive group. In some embodiments, the self-assembly can be triggered by any aqueous environment (or organic environment) without any of the stimulus sensitive groups. However, for stimulus-sensitive applications, these groups may be introduced.

Exemplary light sensitive groups include, but are not limited to, azobenzene derivatives, (PAH/poly[1-[4-(carboxy-4-hydroxyphenylazo)benzenesulfoamido]-1,2-ethanediyl, sodium salt], (PAzo))3/PAH/poly(vinylsulfonate) (PVS). Exemplary pH sensitive groups include, but are not limited to, in essence, ionizable moieties such as the carboxylic acid, amine, azo, phenylboronic acid, imidazole, pyridine, sulfonamide, and thiol groups can confer pH-sensitivity

Exemplary temperature sensitive groups include, but are not limited to, poly(N-isopropylacrylamide), hydroxypropylcellulose, poly(vinylcaprolactame) and polyvinyl methyl ether.

The nanoparticles suitable for forming the NPHAs include hydrophobic nanoparticles and hydrophilic nanoparticles. Exemplary hydrophobic nanoparticles include, but are not limited to, semiconductor quantum dots, precious metal nanoparticles, polymer nanoparticles, lipid nanoparticles, iron oxide nanoparticles, carbon nanoparticles, carbon nanotubues, graphenes, fullerenes, nanowires, nanorods, and the derivatives and combinations thereof.

Exemplary hydrophobic nanoparticles also include, but not limited to, semiconductor quantum dots, precious metal nanoparticles, polymer nanoparticles, lipid nanoparticles, iron oxide nanoparticles, carbon nanoparticles, carbon nanotubues, graphenes, fullerenes, nanowires, nanorods, and the derivatives and combinations thereof.

Note, these same nanoparticles can be hydrophobic or hydrophilic, depending on the surface treatment they receive.

Examples of the hydrophilic polymer include, but are not limited too, polyethylene glycol (or polyethylene oxide), polyanhydrides, poly (acrylic acids), polyacrylamide, poly (methyl vinyl ether), poly (styrene sulfonic acid), poly (vinyl alcohol), poly(2-vinyl N-methyl pyridinium iodide), poly(4-vinyl N-methyl pyridinium iodide), poly(vinylamine) poly(ethylene imine), and the derivatives and combinations thereof; and examples of the hydrophobic polymer include, but are not limited to, poly alkyl (acrylate), polydiene, poly imidazole, polylactone and polylactide, polyolefin, poly oxazoline, polyoxirane, polypyridine, polysiloxane, polystyrene, poly vinyl anthracene/phenanthrene, poly vinyl naphthalene, poly vinylcylcohexane, poly(acrylonitrile), poly(adipic anhydride), poly(ferrocenyldimethylsilane), poly(N-vinyl caprolactam), poly(N-vinyl carbazole), poly(Vinylidene fluoride), poly(vinyl acetate), poly(l-azabicyclo[4.2.0]octane) (polyconidine), poly[1-(trimethylsilyl)-1-propyne], and the derivatives and combinations thereof.

The polymer or the linking group can include an amphiphilic molecule or segment. A wide variety of amphiphiles may be used in connection with the present inventions described herein. The term “amphiphile,” as used herein, refers to a chemical compound that includes a hydrophilic segment and a hydrophobic segment. In certain embodiments of the present inventions, the amphiphile is an amphiphilic block copolymer. In certain other embodiments of the present inventions, the amphiphile is a peptide amphiphile. Suitable amphiphilic block copolymers include, but are not limited to, poly(styrene-b-ethylene glycol), poly(.epsilon.-caprolactone-b-ethylene glycol), poly(ethylene glycol-b-distearoylphophatidylethanolamine), and combinations thereof. Suitable peptide amphiphiles include, but are not limited to, palmitoyl-VVAAEE-NH2, palmitoyl-VVAAEEGIKVAV-COOH, palmitoyl-VVAAEEEEGIKVAV-COOH, and combinations thereof. Those of skill in the art will appreciate that various other amphiphiles may be utilized and are within the scope of the present inventions contemplated herein.

In certain embodiments, the composite nanoparticle structure can include a plurality of hydrophobic nanospecies. In certain exemplary embodiments according to the present inventions described herein, the plurality of hydrophobic nanospecies can comprise one, two, three, four, or more different types of hydrophobic nanospecies. The nanospecies may be naturally hydrophobic or may be modified to have a hydrophobic surface or otherwise rendered hydrophobic. In certain exemplary embodiments of the present inventions, the plurality of hydrophobic nanospecies includes, but is not limited to, semiconducting nanoparticles, metallic nanoparticles, magnetic nanoparticles, carbonaceous nanoparticles, and combinations thereof. Non-limiting examples of such hydrophobic nanoparticles include quantum dots, gold nanoparticles, silver nanoparticles, platinum nanoparticles, iron oxide nanoparticles, superparamagnetic iron oxide nanoparticles, carbon nanotubes, and carbon dots. The various combinations of the types of hydrophobic nanospecies utilized depend primarily on the desired function or application of the resulting composite nanoparticle structures (e.g., magnetic, fluorescent, magnetic and fluorescent, etc.).

In one exemplary embodiment according to the present inventions described herein, the composite nanoparticle structures comprise at least one first quantum dot having a first emission wavelength and at least one second quantum dot having a second emission wavelength that is different from the first emission wavelength. As used herein, the term “quantum dots” refers to semiconductor nanocrystals having unique optical properties such as broad excitation spectra, narrow emission bandwidths, and enhanced photostability. Quantum dots generally have a diameter of about 2 nm to about 10 nm. In one exemplary embodiment, the at least one first quantum dot has a first emission wavelength between 490 nm to 560 nm and the at least one second quantum dot has a second emission wavelength between 590 nm to 700 nm, and the composite nanoparticle structures have an average diameter in a range of 5 nm to 1000 nm. In certain embodiments, the composite nanoparticle structures comprising at least one first quantum dot having a first emission wavelength and at least one second quantum dot having a second emission wavelength have an average diameter in a range of about 10 nm to about 800 nm, including about 20 nm to about 700 nm, including about 25 nm to about 500 nm, including about 30 nm to about 100 nm, including about 30 nm to about 70 nm, and also including about 30 nm to about 50 nm.

Although the exemplary embodiment utilizes at least one first quantum dot having a first emission wavelength between about 490 nm to about 560 nm (i.e., green color) and at least one second quantum dot having a second emission wavelength between about 590 nm to about 700 nm (i.e., red color), various other combinations of quantum dots having different emission wavelengths (i.e., colors) may be utilized in connection with the present inventions described herein. For example, the emission wavelengths may range from about 380 nm to about 800 nm, also including infrared. In certain embodiments, the first emission wavelength may be about 380 nm to 450 nm, or about 450 nm to about 495 nm, or about 495 nm to about 570 nm, or about 570 nm to about 590 nm, or about 590 nm to about 620 nm, or about 620 nm to about 750 nm, and the second emission wavelength may be within any one of the aforementioned ranges that is not the same range as the first emission wavelength. By providing a second emission wavelength that is different from the first emission wavelength the colors emitted by the quantum dots encapsulated within the composite nanoparticle structures are able to be distinguished, which is particularly useful in particle tracking applications, as described in more detail below.

In accordance with the present inventions, in one exemplary embodiment, the composite nanoparticle structure also comprises at least one first quantum dot, and the first quantum dot has a first emission wavelength. In addition, the composite nanoparticle structure comprises at least one second quantum dot encapsulated in the micelle, and the second quantum dot has a second emission wavelength that is different from the first emission wavelength. The composite nanoparticle structure has a diameter in a range of about 5 nm to about 1000 nm. In certain embodiments, the composite nanoparticle structures have an average diameter in a range of about 10 nm to about 800 nm, including about 20 nm to about 700 nm, including about 25 nm to about 500 nm, including about 30 nm to about 100 nm, including about 30 nm to about 70 nm, and also including about 30 nm to about 50 nm. As mentioned above, the emission wavelengths may range from about 380 nm to about 800 nm, also including infrared, and the second emission wavelength is different from the first emission wavelength so that the colors emitted are able to be distinguished.

Composite nanoparticle structures comprising at least one first quantum dot having a first emission wavelength and at least one second quantum dot having a second emission wavelength that is different than the first emission wavelength are particularly useful for particle tracking applications, for example, particle tracking in heterogeneous systems such as living cells and microfluidic flow. By encapsulating quantum dots with differing emission wavelengths into a composite nanoparticle structure, two seemingly irreconcilable problems associated with quantum dots used for particle tracking are solved. The first problem associated with quantum dots is that quantum dots are subject to blinking, an intermittent loss of fluorescence (characteristic of individual and small clusters of quantum dots), that interrupts particle tracking. On the other hand, blinking is the primary method used to confirm quantum dot aggregation status in situ, and single or small clusters of quantum dots with continuous fluorescence emission are difficult to discern from large aggregates. In solving these two problems, the composite nanoparticle structures comprising at least one first quantum dot having a first emission wavelength and at least one second quantum dot having a second emission wavelength that is different than the first emission wavelength exhibit near-continuous, alternating-color fluorescence, which permits aggregation status discrimination by observable color changes even during motion across the focal plane.

Because blinking dynamics are stochastic, a single exemplary composite nanoparticle structure comprising at least one first quantum dot having a first emission wavelength (e.g., 490 nm to 560 nm—green color) and at least one second quantum dot having a second emission wavelength that is different from the first emission wavelength (e.g., 590 nm to 700 nm—red color) remains nearly continuously fluorescent while the emission wavelength alternates between those of the first and second quantum dots, and their combinations. In contrast, large aggregates of the composite nanoparticle structures will display a nearly constant fluorescence emission color, which permits single composite nanoparticle structures (or very small clusters) to be distinguished by their alternating-color emission. Such composite nanoparticle structures, therefore, can be continuously tracked and identified as a single composite nanoparticle structure or a very small cluster of composite nanoparticle structures.

In addition, composite nanoparticle structures comprising at least one first quantum dot having a first emission wavelength and at least one second quantum dot having a second emission wavelength that is different than the first emission wavelength may be used to distinguish the composite nanoparticle structure from background fluorescence emitted in a wavelength channel that overlaps with the first emission wavelength or the second emission wavelength. For example, if there is too much background fluorescence at 500 nm, then it would still be possible to distinguish a composite nanoparticle structure comprising quantum dots having an emission wavelength of 490 nm to 560 nm and quantum dots having an emission wavelength of 590 nm to 700 nm by imaging at, for example, 650 nm.

In accordance with the present inventions described herein, in one exemplary embodiment, the composite nanoparticle structure comprises a plurality of quantum dots having the same emission wavelength. In this particular embodiment, the brightness of the fluorescence emission is increased without increasing the size of composite nanoparticle structure.

In one exemplary embodiment of the present inventions, the composite nanoparticle structure comprising at least one first quantum dot having a first emission wavelength and at least one second quantum dot having a second emission wavelength that is different from the first emission wavelength further comprises at least one additional nanospecies. For example, the at least one additional nanospecies includes, but is not limited to, nanospecies selected from the group consisting of magnetic nanoparticles, metallic nanoparticles, carbonaceous nanoparticles, and combinations thereof. The additional nanospecies increases the functionality of the composite nanoparticle structure (e.g., a magnetic nanoparticle enables manipulation of the composite nanoparticle structure by a magnetic field) to broaden the applications of the composite nanoparticle structures.

According to the present inventions described herein, in one exemplary embodiment, the composite nanoparticle structure comprises at least one quantum dot and at least one magnetic nanoparticle, and the composite nanoparticle structures have an average diameter in a range of about 5 nm to about 1000 nm. The magnetic nanoparticle may comprise an iron oxide nanoparticle, a superparamagnetic iron oxide nanoparticles, or various other magnetic nanoparticles of iron, nickel, cobalt, compounds thereof, and combinations thereof. As mentioned above, in certain embodiments, the composite nanoparticle structures have an average diameter in a range of about 10 nm to about 800 nm, including about 20 nm to about 700 nm, including about 25 nm to about 500 nm, including about 30 nm to about 100 nm, including about 30 nm to about 70 nm, and also including about 30 nm to about 50 nm.

Composite nanoparticle structures comprising at least one quantum dot and at least one magnetic nanoparticle have a vast number of applications based upon their fluorescent and magnetic properties. The fluorescence imparted by the quantum dots allows the composite nanoparticle structures to used as imaging agents in traditional diagnostic applications (e.g., immunocytochemistry), whereas the magnetic property from the magnetic nanoparticles allows the composite nanoparticle structures to be manipulated by a magnetic field, which can lead to the design of magnetically targeted nanostructures. In addition, such composite nanoparticle structures can be used to isolate and characterize the molecular profiles of cancer cells, such as circulating tumor cells, and to perform multimodal in vivo tumor visualization through magnetic resonance and fluorescent imaging. Moreover, such composite nanoparticle structures can be used in vitro to manipulate and track cells, biomolecules, and nanostructures.

In one exemplary embodiment according to the present inventions, the composite nanoparticle structures further comprise a functional group. More specifically, the functional group is conjugated to, bound to, or otherwise attached to the composite nanoparticle structure, or the composite nanoparticle structure is conjugated to, bound to, or otherwise attached to the functional group. The functional group can be virtually any molecule that is useful for biological, environmental, or various other applications. In certain embodiments of the present inventions, the functional group is selected from the group consisting of a peptide, a polypeptide, a protein, a ligand, an antibody, DNA, RNA, and combinations thereof. However, the functional group may comprise virtually any compound or molecule designed to target and bind to, for example, specific types of cells, proteins, and so forth. Thus, the term “functional group,” as used herein, broadly encompasses compounds or molecules designed to target a specific entity. In essence, a composite nanoparticle structure may be labeled with a functional group, or a functional group may be labeled with a composite nanoparticle structure. For example, in one exemplary embodiment, the composite nanoparticle structure is conjugated with an antibody that targets a specific cell population. There are several methods of crosslinking or conjugating or otherwise attaching proteins, ligands, antibodies, molecular fragments, and the like through chemical modifications known in the art that may be utilized in connection with the present inventions described herein. For example, carbodiimide (EDC) chemistry or NHS-ester crosslinker chemistry may be utilized to conjugate, crosslink, bind, or otherwise attach a functional group to a composite nanoparticle structure, and vice versa.

In certain embodiments contemplated by the present inventions, the method of producing polymeric nanoparticles includes mixing or stirring the aqueous collection solution containing the plurality of droplets. The mixing or stirring step may better disperse the plurality of droplets within the aqueous collection solution to aid in the formation of the polymeric nanoparticles.

As previously noted, the polymeric nanoparticles of the contemplated general inventive concepts are useful for controlled release delivery systems. Accordingly, in one exemplary embodiment, the organic phase fluid further comprises an active ingredient, and the polymeric nanoparticles comprise self-assembled structures, such as amphiphilic micelles, encapsulating the hydrophobic polymer and the active ingredient. In another embodiment, the active ingredient may be supplied in the aqueous phase fluid. The active ingredient may be virtually any molecule or compound, including but not limited to, anticancer drugs, therapeutic proteins, antibiotics, skin care agents, fertilizers, and so forth. In an exemplary embodiment, the particle size of the polymeric nanoparticles (e.g., <100 nm) contemplated by the present inventions described herein provides a number of advantages in the delivery of an active ingredient including, but not limited to, a better half-life in the blood stream, increased colloidal stability, faster release, deeper penetration into tissue, and so forth.

In one exemplary embodiment, the polymeric nanoparticles further comprise a functional group. The functional group can be virtually any molecule that is useful for biological, environmental, or various other applications. In certain embodiments of the present inventions, the functional group is selected from the group consisting of a peptide, a polypeptide, a protein, a ligand, an antibody, DNA, RNA, and combinations thereof. However, the functional group may comprise virtually any compound or molecule designed to target and bind to, for example, specific types of cells, proteins, and so forth. Thus, the term “functional group,” as used herein, broadly encompasses compounds or molecules designed to target a specific entity. The functional group may be conjugated to, bound to, crosslinked to, or otherwise attached to the polymeric nanoparticle. Similarly, the polymeric nanoparticle may be conjugated to, bound to, crosslinked to, or otherwise attached to the functional group. In essence, a polymeric nanoparticle may be labeled with a functional group, or a functional group may be labeled with a polymeric nanoparticle. For example, in one exemplary embodiment, the polymeric nanoparticle is conjugated with an antibody that targets a specific cell population. There are several methods of crosslinking or conjugating or otherwise attaching proteins, ligands, antibodies, molecular fragments, and the like through chemical modifications known in the art that may be utilized in connection with the present inventions described herein. For example, carbodiimide (EDC) chemistry or NHS-ester crosslinker chemistry may be utilized to conjugate, crosslink, bind, or otherwise attach a functional group to a polymeric nanoparticle, and vice versa.

As previously mentioned, a wide variety of amphiphiles may be used in connection with the present inventions described herein. In certain embodiments of the present inventions, the amphiphile is an amphiphilic block copolymer. In certain other embodiments of the present inventions, the amphiphile is a peptide amphiphile. Suitable amphiphilic block copolymers include, but are not limited to, poly(styrene-b-ethylene glycol), poly(.epsilon.-caprolactone-b-ethylene glycol), poly(ethylene glycol-b-distearoylphophatidylethanolamine), and combinations thereof. Suitable peptide amphiphiles include, but are not limited to, palmitoyl-VVAAEE-NH2, palmitoyl-VVAAEEGIKVAV-COOH, palmitoyl-VVAAEEEEGIKVAV-COOH, and combinations thereof. Those of skill in the art will appreciate that various other amphiphiles may be utilized and are within the scope of the present inventions contemplated herein.

In certain embodiments, the polymer is a hydrophobic polymer. A wide variety of hydrophobic polymers may be utilized in accordance with the present inventions. In certain embodiments, the hydrophobic polymer is biocompatible and biodegradable. For example, in one exemplary embodiment, the hydrophobic polymer is poly(lactic-co-glycolic acid). However, other hydrophobic polymers are contemplated in accordance with the present inventions including, but not limited to, poly(lactic-co-glycolic acid), poly(lactic acid), poly(glycolic acid), poly(caprolactone), poly(ethylene glycol), and combinations thereof. In certain embodiments, the hydrophobic polymer is supplied to the nozzle in the organic phase fluid. For instance, the hydrophobic polymer is dispersed, dissolved, or otherwise added to the organic phase fluid.

In other embodiments, the polymer is a hydrophilic polymer. A wide variety of hydrophilic polymers may be utilized in accordance with the present inventions described herein. For example, suitable hydrophilic polymers include, but are not limited to, acrylates, methacrylates, poly(ethylene oxide), cellulose ethers. Many other hydrophilic polymers are known to those of skill in the art and are contemplated herein. In certain embodiments, the hydrophilic polymer is supplied to the nozzle in the aqueous phase fluid. For example, the hydrophilic polymer is dispersed, dissolved, or otherwise added to the aqueous phase fluid.

### Method of Forming Composite Nanoparticle Structure

Referring now to FIG. 1, a schematic illustration of a method for producing composite nanoparticle structures according to one exemplary embodiment is shown. In general, the method for producing composite nanoparticle structures comprises providing a plurality of NPHAs and causing the NPHAs to assemble into a composite nanoparticle structure.

The process of the self-assembly is performed by a method selected from the following list, which includes, but is not limited to, film hydration, direct dissolution, nanoprecipitation, interfacial instability, dialysis, electrospray, extrusion, and sonication, The control of particle size and “molecular formula” (numbers of each different nanoparticles-polymer conjugates in the assembly) is given by parameters including but not limited to sizes of nanoparticles and polymers, hydrophobicity/hydrophilicites of nanoparticles and polymers, temperature, molecular environments.

### Method of Forming NPHAs

Methods of forming the NPHAs of invention generally include providing a nanoparticle, which is hydrophobic or hydrophilic, providing a polymer, which has a hydrophobicity/hydrophilicity generally opposite to that of the nanoparticle, and coupling the nanoparticle and the polymer to form an NPHA. Suitable nanoparticles and polymers are as described above.

Coupling the nanoparticle with the polymer can be readily achieved by chemical bonding or physical conjugation. Chemical bonding covalent bonding or complexation and can be achieved using a reactive group on the nanoparticle or the polymer or sometimes, using a linking group. Reactive groups on the polymer or nanoparticle can be carboxylic groups, hydroxyl groups, amino groups, thiol groups, carboxylic groups, or any other groups capable of reacting with a group on the nanoparticle surface. The linking group can be on the nanoparticle or on the polymer.

In some embodiments, the linking group have atom(s) which are electron donor or acceptors such that complexation can occur between the atoms on the linking group and atoms on the nanoparticle surface or the polymer. One such linking group can be EDTA where the carboxylic groups allow EDTA to complex with a metallic atom on the surface of the nanoparticle.

### Method of Using the Composite Nanoparticle Structures

The applications of composite nanoparticle structures prepared by the method disclosed herein are numerous, ranging from cancer imaging to solar cells, as well as environmental monitoring. Further, as a platform technology, this new technology has great potential to lead to many more new inventions.

### EXAMPLES

The following examples illustrate exemplary embodiments or features of the present inventions described herein. The examples are given solely for the purpose of illustration and are not to be construed as limitations of the present inventions, as many variations thereof are possible without departing from the spirit and scope of the present inventions.

### Example 1

### Materials and Methods

### Chemicals

Poly(styrene-b-ethylene glycol) with molecular weight 3800-b-6500 (Dalton) can be purchased from Polymer Source. Quantum dots (QDs) with hydrophobic surfaces (lamdaₑₘ=545 nm, 10 pmol for green QDs, and lamdaₑₘ=605 nm, 2 pmol for red QDs) can be purchased from Invitrogen. Chloroform and poly(vinyl alcohol) (13,000-23,000 Dalton, 87-89% hydrolyzed) can be purchased from Aldrich. Dulbecco's modified Eagle's medium and fetal bovine serum for culturing NIH3T3 cells can be purchased from ATCC.

### Preparation of Composite Nanoparticle Structures

Quantum dot (hydrophobic, with amine-modified triocytlphosphine oxide on the surface)-poly(ethylene glycol) (hydrophilic, modified with carboxyl group) conjugate is formed by EDAC chemistry. Similarly by EDAC conjugation chemistry Iron oxide nanoparticles (hydrophobic)-poly(ethylene glycol) (hydrophilic) conjugate is formed. Then, an oil phase is formed by mixing iron oxide nanoparticles-poly(ethylene glycol) conjugate and quantum dot-poly(ethylene glycol) conjugate in tetrahydrofuran. The oil phase is added to a large anqueous phase with mechanical stirring. The thus formed mixture is dialyzed against pure water overnight, resulting in NPHAs.

### Transmission Electron Microscopy (TEM)

The composite nanoparticle structures (CNPSs) are negatively stained with 1% phosphotungstic acid (PTA). TEM studies can be conducted using an FEI Tecnai G2 Spirit Transmission Electron Microscope (80 kV). QDs and PTA are electron dense and appear dark, whereas the shells of micelles appear light in the images.

### Fluorescent Microscopy and Image Analysis

To uniformly disperse CNPSs on a coverslip surface, CNPS solution (10 μl, 1-10 nM) can be sandwiched between two coverslips and placed in a fume hood for 10 minutes. The two coverslips can be then separated and exposed to ambient conditions for another 10 minutes. Coverslips can be then secured to microscopy slides for fluorescent microscopy observation. CNPSs can be imaged with an Olympus BX41 microscope (100.times.oil immersion objective) equipped with a 100 W mercury lamp (Chiu Technical Corporation, lamdaₑₓ=488 nm. Fluorescent emission can be filtered through a long-pass filter and collected by an Olympus DP70 CCD camera. Image analysis can be conducted using Image J image analysis software. Fluorescent intensity of a pixel can be determined by its gray level. Fluorescent intensity of a particle can be determined by multiplying the mean gray level of all pixels of the particle by the area (number of pixels) occupied by the particle. A trajectory of a particle can be identified by manually linking the particle centroids on all frames of a time series. Movement of different particles through the focal plane can be imaged by manually adjusting the microscope stage. Camera exposure time used can be 500 ms for QD blinking and CNPS alternating color images, 16.7 ms for QD aggregates, and 0.8 ms for the CNPS aggregates.

### Estimation of FRET Efficiency Between QDs

The FRET efficiency between the two QD sizes used can be estimated as follows:

$${R}_{0} = {( \frac{9000 ( ln 10 ) {k}^{2} {Q}_{D}}{128 {π}^{5} {Nn}^{4}} \times I )}^{\frac{1}{6}} \approx 3.9 nm \qquad ( 1 )$$

where R₀=Forster distance, I=spectral overlap function=2.2309×10¹⁵ (obtained by integrating the area under the overlap area of donor QD and acceptor QD), k²=orientation factor=2/e, QD=donor quantum yield=80% (as per QD manufacturer0, N=Avogardo's number=6.02×10²³, and n=refractive index=2.2 (average of refractive index of CdSe and polystyrene).

$$E = \frac{{R}_{0}^{6}}{{R}_{0}^{6} + {r}^{6}} \qquad ( 2 )$$

where E=FRET efficiency and r=distance between centers of QD FRET pair.

Assuming a zero separation between the two QDs (i.e., two QDs touching each other), the distance between FRET donor and acceptor is the sum of the radii of the two QDs. The QD radii as measured by TEM are: r=r₁+r₂=2.05+3.45=5.48 nm; thus, E=13.1%, and with 1 nm separation between two QDs, E=5.2%.

CNPS suitability for particle tracking applications can be assessed using a fluorescent microscope (lamda_{excitation}=488 nm), CCD camera, and long-pass filter to permit simultaneous green and red channel observation. The CNPSs exhibit multiple, alternating fluorescence emission colors, including those of the constituent green and red QDs and their combination (data not shown). The ratio of fluorescence in the CNPS red channel to that of the green channel (R/G ratio) changed throughout the observation period (0.564-3.662 AU, or 550% difference, data not shown), leading to a continuous change in fluorescent color (data not shown). The change in R/G ratio can be abrupt; indicating an abrupt color change between red (high R/G ratio), yellow/orange (medium R/G ratio), and green (low R/G ratio). Additionally, the fluorescent colors of smaller regions within the CNPS also changed continuously and abruptly. For example, in frame 41 (5.453 s), the CNPS appears as a large orange core surrounded by a thin red shell (R/G ratio=1.846), whereas in frame 110 (14.497 s) the CNPS appears green (R/G ratio=0.580). The nonuniform color distribution in the CNPS indicates a heterogeneous distribution of differently colored QDs in the CNP. In contrast, a large aggregate of CNPSs (obtained from the visible precipitate of an unfiltered CNPS solution after 1 week of storage) exhibited near-constant fluorescent color and R/G ratio (2.931-3.004 AU, or 2.4% difference). Therefore, the alternating-color feature of the CNPS can serve as a marker of single (or small cluster) status.

To evaluate the dynamics of fluorescence intensity, overall CNPS fluorescence intensity and that of individual red and green channels can be compared with the intensity of separately imaged single green and red QDs (data not shown). Over an observation period of 2 min, the total CNPS fluorescence intensity remains high (ranging from 588.07 to 2995.998 AU), although at several time points the fluorescent intensities of individual CNPS color channels can be diminished as a result of constituent QD blinking (data not shown). Compared to individual QDs, for which fluorescence can be nearly extinguished at several time points (data not shown, green QD, 0-408.000 AU; red QD, 13.988-1429.012 AU), CNPS fluorescence can be virtually continuous. Additionally, CNPSs are much brighter than constituent QDs, which will significantly improve signal-to-noise ratio in tracking studies.

These measurements can also be used to estimate the number of constituent QDs in a CNP, which is important for potential multiplexing applications. If numbers of individual constituent QDs can be determined in situ, it would be possible to construct CNPSs with known red to green particle ratios, which could then be used to track different species. From comparison of fluorescence intensity in CNPS channels (data not shown) to that of single QDs (data not shown) (integrated over 10 s to compensate for blinking), it is estimated that the CNPS shown in (data not shown) contains four (i.e., 4.09) green QDs and two (i.e., 2.24) red QDs. However, given the spectral overlap and close proximity between QDs with a CNPS, Forster resonance energy transfer (FRET) could occur. Thus, the FRET efficiency between green and red QDs can be calculated and determined to be low (13.1% for 0 nm and 5.2% for 1 nm separation). The low FRET efficiency observed in QD-QD pairs relative to molecular FRET donor/acceptors results from the large size of QDs. These calculations indicate that FRET does not significantly interfere with the fluorescent properties of the CNPSs.

In addition to permitting near continuous tracking and confirmation of aggregation status, the alternating-color fluorescence emission can be used to solve another long-standing problem in QD-based particle tracking: discrimination of out-of-focus large aggregates from single (or small clusters of) nanoparticles. In highly dynamic systems using conventional QDs, rapid 3D motion out of the focal plane cannot be distinguished from blinking because both lead to disappearance of the fluorescence signal (data not shown). In contrast, CNPSs permit facile and unambiguous confirmation of aggregation status because (1) CNPSs produce alternating-color fluorescence emission and (2) the constituent QDs in a CNPS move as an ensemble. Thus, aCNPS aggregate completely moving out of focus manifests as a complete loss of fluorescence, which is clearly distinguishable from the alternating-color signal of a single (or small cluster of) CNPS (data not shown).

Drop-cast CNPSs can be moved by manual control of the microscope stage. A typical CNPS can be tracked continuously for 2 min, much longer than the reported duration between blinking interruptions for any single QD-trajectory reported in the literature (data not shown). The CNPS moved throughout the field of view while exhibiting continuous and abrupt color changes, indicating single (or small cluster) status. CNPS alternating-color fluorescence is distinguishable from potential fluorescent intensity and color changes that may result from particle growth (e.g., by Ostwald ripening) and aggregation. It has been reported that the fluorescence intensity of some large QD aggregates (e.g., QDs with poorly protected surfaces) experience a significant, but gradual, decay before reaching steady state under certain experimental conditions. However, large CNPS aggregates, which comprise commercially available QDs with well-protected surfaces, emit constant fluorescence in all color channels under all experimental conditions tested. Additionally, even if particles with poorly protected surfaces can be used, because the initial decay of fluorescence would be gradual, any possible alteration of fluorescence would also be gradual and could thus be distinguished from the abrupt color changes exhibited by single (or small cluster of) CNPSs.

There can be several fast and large location changes (“jumps”) in the trajectory (e.g., from 84.44 to 87.22 s). In particular, a color-changing event coincided with the jump event between 84.44 and 86.67 s (data not shown). The color-changing event indicates that during this time at least one constituent QD in the CNPS can be blinking, which highlights the benefit of using a CNPS rather than a QD for tracking If this constituent blinking QD alone can be used as a tracer particle, the trajectory after the “jump” would be lost due to the coincidence of the blinking and the jump. Alternatively, “nonblinking QDs” in which blinking is reduces or eliminated by mediators/compensators on the QD surface, coating QDs with a thick shell, or synthesizing QDs with a gradually changing potential energy function could be used. However, these would not permit aggregation status (or lack thereof) to be confirmed, since blinking would be absent, electron microscopy and single photon counting could not be applied in situ, and the fluorescent particle spot size can vary with camera exposure time and is subject to the diffraction limit (i.e., not the actual size of the particle).

In addition to the optical properties, CNPSs have several features that make them particularly useful for particle tracking studies. First, about 20% of the as-synthesized CNPSs, without separation or optimization, show near-continuous fluorescence, alternating-color properties (with the remainder providing typical single color fluorescence). Second, yields can be enhanced by fluorescence sorting (e.g., FACS); however, CNPSs can also be used as-synthesized with investigators selectively tracking those fluorescent particles with the alternating-color feature. Third, CNPSs are small and are therefore not expected to interfere with most processes being tracked. Further, bioconjugation of CNPSs can be accomplished by well-documented procedures (using amphiphilic polymers with —COOH or —NH.sub.2 end groups). In addition, CNPSs are stable in the biological environments commonly used for particle tracking studies. For example, after 12 h in cell culture medium (Dulbecco's modified Eagle's medium, containing 10% serum, 37.degree.C.), CNPSs can be free of significant aggregation and their near-continuous fluorescence and alternating-color properties can be preserved. Cell culture medium, blood, or cytoplasm can all potentially interact with the QD surface through oxidation/reduction reactions or molecular absorption to alter QD properties. The high tolerance for biological environments displayed by CNPSs should at least partially result from protection of the QD surface by the micelle.

The properties of the CNPSs can significantly enhance dynamic particle tracking in fluids (e.g., biological environments or microfluidic flows). However, it is contemplated that CNPSs can be used for magnetic manipulation and multimodal imaging, or for use in creating multiplexed particles that can track multiple biomolecules or nanomaterials simultaneously. In addition, CNPSs may also serve as a platform for investigating energy transfer and electronic coupling of QDs in a controlled microenvironment.

### Example 2

Example 2 illustrates one exemplary embodiment of a method of using a composite nanoparticle structure according to the present inventions described herein.

Nanoscale force sensors for biomechanics studies. As a nanoscale force sensor, composite nanoparticle structures comprising micelles co-encapsulating quantum dots (QDs) and superparamagnetic iron oxide nanoparticles (SPIONs) are used to identify the biological object to be studied. A well-defined external force is then applied on the biological object by a magnetic micromanipulator, and the change of location of the biological object due to the force is tracked by the fluorescence of the QDs.

I claim:

1. A method for producing a composite nanoparticle structure, the method comprising:
providing a plurality of nanoparticle-polymer hybrid amphiphiles (NPHAs), and
causing the plurality of NPHAs to spontaneously assemble into a composite nanoparticle structure.

2. The method of claim 1, wherein the composite nanoparticle structure comprises at least 2 NPHAs.

3. The method of claim 1, wherein the composite nanoparticle structure comprises at least 5 NPHAs.

4. The method of claim 1, wherein the composite nanoparticle structure comprises at least 10 NPHAs.

5. The method of claim 1, wherein the NPHA comprises:
(a) a hydrophobic nanoparticle and a hydrophilic polymer, or
(b) a hydrophilic nanoparticle and a hydrophobic polymer.

6. The method of claim 5, wherein the NPHA comprises a hydrophobic nanoparticle and a hydrophilic polymer,
wherein the hydrophobic nanoparticle is selected from the group consisting of hydrophobic semiconductor quantum dots, precious metal nanoparticles, polymer nanoparticles, lipid nanoparticles, iron oxide nanoparticles, carbon nanoparticles, carbon nanotubues, graphenes, fullerenes, nanowires, nanorods, and the derivatives and combinations thereof, and
wherein the hydrophilic polymer is selected from the group consisting of polyethylene glycol (or polyethylene oxide), polyanhydrides, poly (acrylic acids), polyacrylamide, poly (methyl vinyl ether), poly (styrene sulfonic acid), poly (vinyl alcohol), poly(2-vinyl N-methyl pyridinium iodide), poly(4-vinyl N-methyl pyridinium iodide), poly(vinylamine) poly(ethylene imine), and the derivatives and combinations thereof.

7. The method of claim 5, wherein the NPHA comprises a hydrophilic nanoparticle and a hydrophobic polymer,
wherein the hydrophilic nanoparticle is selected from the group consisting of hydrophilic semiconductor quantum dots, precious metal nanoparticles, polymer nanoparticles, lipid nanoparticles, iron oxide nanoparticles, carbon nanoparticles, carbon nanotubues, graphenes, fullerenes, nanowires, nanorods, and the derivatives and combinations thereof, and
wherein the hydrophobic polymer is selected from the group consisting of poly alkyl (acrylate), polydiene, poly imidazole, polylactone and polylactide, polyolefin, poly oxazoline, polyoxirane, polypyridine, polysiloxane, polystyrene, poly vinyl anthracene/phenanthrene, poly vinyl naphthalene, poly vinylcylcohexane, poly(acrylonitrile), poly(adipic anhydride), poly(ferrocenyldimethylsilane), poly(N-vinyl caprolactam), poly(N-vinyl carbazole), poly(Vinylidene fluoride), poly(vinyl acetate), poly(l-azabicyclo[4.2.0]octane) (polyconidine), poly[1-(trimethylsilyl)-1-propyne], and the derivatives and combinations thereof.

8. The method of claim 1, wherein causing the plurality of NPHAs to spontaneously assemble into a composite nanoparticle structure comprises a process selected from the group consisting of film hydration, direct dissolution, nanoprecipitation, interfacial instability, dialysis, electrospray, extrusion, and sonication.

9. The method of claim 1, wherein causing comprises dissolving the plurality of NPHAs in an organic solvent, and allowing the NPHAs to assemble into the composite nanoparticle structure.

10. The method of claim 9, wherein the organic solvent is selected from the group consisting of chloroform, tetrahydrofuran, dichloromethane, and combinations thereof; the amphiphile is selected from the group consisting of poly(styrene-b-ethylene glycol), poly(.epsilon.-caprolactone-b-ethylene glycol), poly(ethylene glycol-b-distearoylphosphatidylethanolamine), a peptide amphiphile, and combinations thereof; and the plurality of hydrophobic nanoparticles is selected from the group consisting of semiconducting nanoparticles, metallic nanoparticles, magnetic nanoparticles, carbonaceous nanoparticles, and combinations thereof.

11. The method of claim 1, wherein the composite nanoparticle structure has a diameter in a range of about 5 nm to about 1000 nm.

12. The method of claim 1, wherein the composite nanoparticle structure comprises at least one first quantum dot having a first emission wavelength and at least one second quantum dot having a second emission wavelength that is different from the first emission wavelength, and the composite nanoparticle structure has a diameter in a range of about 5 nm to about 1000 nm.

13. The method of claim 1, wherein the composite nanoparticle structure comprises at least one quantum dot and at least one magnetic nanoparticle, and the composite nanoparticle structure has a diameter in a range of about 5 nm to about 1000 nm.

14. The method of claim 1, wherein the composite nanoparticle structure further comprises a functional group, wherein the functional group is selected from the group consisting of a peptide, a polypeptide, a protein, a ligand, an antibody, DNA, RNA, and combinations thereof.

15. The method of claim 1, wherein the NPHAs comprise a nanoparticle selected from the group consisting of metallic nanoparticles, magnetic nanoparticles, carbonaceous nanoparticles, and combinations thereof.

16. The method of claim 12, wherein the first emission wavelength is between about 490 nm to about 560 nm and the second emission wavelength is between about 590 nm to about 700 nm.

17. A composite nanoparticle structure comprising a plurality of nanoparticle-polymer hybrid amphiphiles (NPHAs), wherein the NPHA comprises:
(a) a hydrophobic nanoparticle and a hydrophilic polymer, or
(b) a hydrophilic nanoparticle and a hydrophobic polymer.

18. The composite nanoparticle structure of claim 17, wherein the NPHA comprises a hydrophobic nanoparticle and a hydrophilic polymer,
wherein the hydrophobic nanoparticle is selected from the group consisting of hydrophobic semiconductor quantum dots, precious metal nanoparticles, polymer nanoparticles, lipid nanoparticles, iron oxide nanoparticles, carbon nanoparticles, carbon nanotubues, graphenes, fullerenes, nanowires, nanorods, and the derivatives and combinations thereof, and
wherein the hydrophilic polymer is selected from the group consisting of polyethylene glycol (or polyethylene oxide), polyanhydrides, poly (acrylic acids), polyacrylamide, poly (methyl vinyl ether), poly (styrene sulfonic acid), poly (vinyl alcohol), poly(2-vinyl N-methyl pyridinium iodide), poly(4-vinyl N-methyl pyridinium iodide), poly(vinylamine) poly(ethylene imine), and the derivatives and combinations thereof.

19. The composite nanoparticle structure of claim 17, wherein the NPHA comprises a hydrophilic nanoparticle and a hydrophobic polymer,
wherein the hydrophilic nanoparticle is selected from the group consisting of hydrophilic semiconductor quantum dots, precious metal nanoparticles, polymer nanoparticles, lipid nanoparticles, iron oxide nanoparticles, carbon nanoparticles, carbon nanotubues, graphenes, fullerenes, nanowires, nanorods, and the derivatives and combinations thereof, and
wherein the hydrophobic polymer is selected from the group consisting of poly alkyl (acrylate), polydiene, poly imidazole, polylactone and polylactide, polyolefin, poly oxazoline, polyoxirane, polypyridine, polysiloxane, polystyrene, poly vinyl anthracene/phenanthrene, poly vinyl naphthalene, poly vinylcylcohexane, poly(acrylonitrile), poly(adipic anhydride), poly(ferrocenyldimethylsilane), poly(N-vinyl caprolactam), poly(N-vinyl carbazole), poly(Vinylidene fluoride), poly(vinyl acetate), poly(l-azabicyclo[4.2.0]octane) (polyconidine), poly[1-(trimethylsilyl)-1-propyne], and the derivatives and combinations thereof.

20. The composite nanoparticle structure of claim 17, comprising at least one first quantum dot encapsulated in the assembly structure (including but not limited to micelle and vesicle types of structures), the first quantum dot having a first emission wavelength; at least one second quantum dot encapsulated in the micelle, the second quantum dot having a second emission wavelength that is different from the first emission wavelength; and the composite nanoparticle structure having a diameter in a range of about 5 nm to about 1000 nm.

21. The composite nanoparticle structure of claim 17, further comprising at least one additional nanoparticle encapsulated in the micelle, the additional nanoparticle selected from the group consisting of metallic nanoparticles, magnetic nanoparticles, carbonaceous nanoparticles, and combinations thereof.

22. The composite nanoparticle structure of claim 18, wherein the first emission wavelength is between about 490 nm to about 560 nm and the second emission wavelength is between about 590 nm to about 700 nm.
